(19) United States
(12) Patent Application Publication
(10) Pub. No.: US 2002/0046813 A1
(43) Pub. Date: Apr. 25, 2002

(54) Arrangement for processing printed products

(76) Inventor: Peter Merkli, Oftringen (CH)

Correspondence Address: VENABLE, BAETJER, HOWARD AND CIVILETTI, LLP, P.O. BOX 34385, WASHINGTON, DC, 20043-9998, US

(21) Appl. No.: 09/977,975

(22) Filed: Oct. 17, 2001

(30) Foreign Application Priority Data
Oct. 20, 2000 (EP) 00810973.8

(51) Int. Cl. B65C 1/00

(52) U.S. Cl. 156/556; 156/297

(57) ABSTRACT

An arrangement for processing printed products includes a conveying device for conveying the printed products and a feeding device for feeding the printed products to the conveying device. A plurality of processing stations are arranged along the conveying device for processing the printed products. A removal device removes the printed products from the conveying device. Several of the processing stations are subdivided into at cast two sections. Each section includes at least two processing stations. The arrangement is adapted for passing the products through each section with a differing speed.

### CROSS-REFERENCE TO RELATED APPLICATIONS

Priority is claimed with respect to application No. 00810973.8 filed in the European Patent Office On Oct. 20, 2000, the disclosure of which is incorporated herein be reference.

### BACKGROUND OF THE INVENTION

The invention relates to an arrangement for processing printed products comprising a conveying device for conveying the printed products; a feeding device for feeding the printed products to the conveying device; a plurality of processing stations arranged along the conveying device for processing the printed products; and a removal device for removing the printed products from the conveying device.

Arrangements of i type have long been known, for example as revolving adhesive binding machines. These machines comprise several processing stations for book production, in particular a routing station, a book back lowering station, a gluing station and a cover press-on station The book block to be processed is guided to these stations and is processed accordingly.

Comparably cost-effective arrangements are known for the manual production of books, which arrangements work with a gripper that passes through the various processing stations and then returns to the original station. An arrangement of this type permits individual book production. However, the comparatively small output is a disadvantage, making an arrangement of this type not suitable for a large-scale book production.

An arrangement suitable for the large-scale book production is disclosed in Germ patent document DFA-33 01 032. This arrangement is designed for producing book blocks with adhesive applied to the back. For processing, the book blocks are inserted with the aid of a feeding device into the receptacles of a turret arrangement. The turret or revolving table can be operated intermittently in a stepped operation, so that the book blocks to be processed are advanced as a result of the turret rotation to the, processing stations. The spacing of the receptacles is designed such that during a first rotation in the turret, the book blocks are moved past a removal device. They reach the removal device only after the second or third rotation and are removed by it. The book blocks pass with uniform speed through the processing stations. The arrangement permits producing large book series, which are all identical.

The above-mentioned arrangement for the manual production as well as the known arrangement for the large-scale production are not suitable for printing machines, in particular digital printers, which permit a so-called “on demand” production. With this type of production, the printer output is irregular and individual. Thinner products are printed during a shorter time than thicker products. Smaller series as well as larger series are produced. The book blocks thus cm vary considerably. A manual book production is not useful owing to tile high output of such printers.

### SUMMARY OF THE INVENTION

It is an object of the invention to create an arrangement of the aforementioned type, which is especially suitable for an “on demand” production and which additionally ensures a considerably higher output tan manual production.

The above and other objects are accomplished in the context of the arrangement as first mentioned above, wherein, in accordance with the invention, several of the processing stations are subdivided into at least two sections, each section including at least two processing stations, and wherein the arrangement further includes a mechanism for passing the products through each section with a differing speed.

In particular with a revolving adhesive binder, the sections or processing steps can be selected such that a switch to an optional waiting period can occur after passing through a section. It is essential for adhesive binding, for example, that the cover is pressed against the book back, immediately following the processing step of applying adhesive. Otherwise, be applied adhesive will dry up or cool down and the cover attached with a delay will no longer adhere fully. In is way, the processing speed that is important to the quality of the production can always remain the same during the critical steps and, in particular, during the routing or when applying adhesive or pressing on the cover. The production capacity of the adhesive binder nevertheless can be adapted within far-reaching limits to the requirements of the printing machine or any other feeding machine since the waiting periods between sections can be varied individually.

The pass-through speed can vary, for example, such that in the second half of a section the speed can be lower than in the fist half. In the second half, the speed can even be lowered to zero, so that the machine stops completely. Certain processing operations can thus be carried out at slow speed or even during a standstill. Processing steps carried out at a low speed or during a standstill, include, in particular, the pressing on of the cover following the adhesive application.

The arrangement according to the invention additionally has the advantage that the processing can be adapted to the irregular output of a printing machine, thus permitting in particular a processing “on demand” with a structurally simple solution. Loose book blocks in particular do not have to be inserted at fit speed or covers pressed on while passing through. These processing steps can be carried out during a standstill. In addition, the processing quality can be improved since more time is available for the respective processing steps, e.g. for pressing the cover against the book block.

Further advantageous characteristics follow from the following description, as well as the drawing. One exemplary embodiment of the invention is explained in further detail in the following wit:f the aid of the drawing.

### BRIEF DESCRIPTION Of THE DRAWINGS

FIG. 1 is a schematic plan view of an arrangement according to the invention.

FIG. 2 is a diagram showing a speed/time diagram of the course of the speed in one section.

### DETAILED DESCRIPTION OF INVENTION

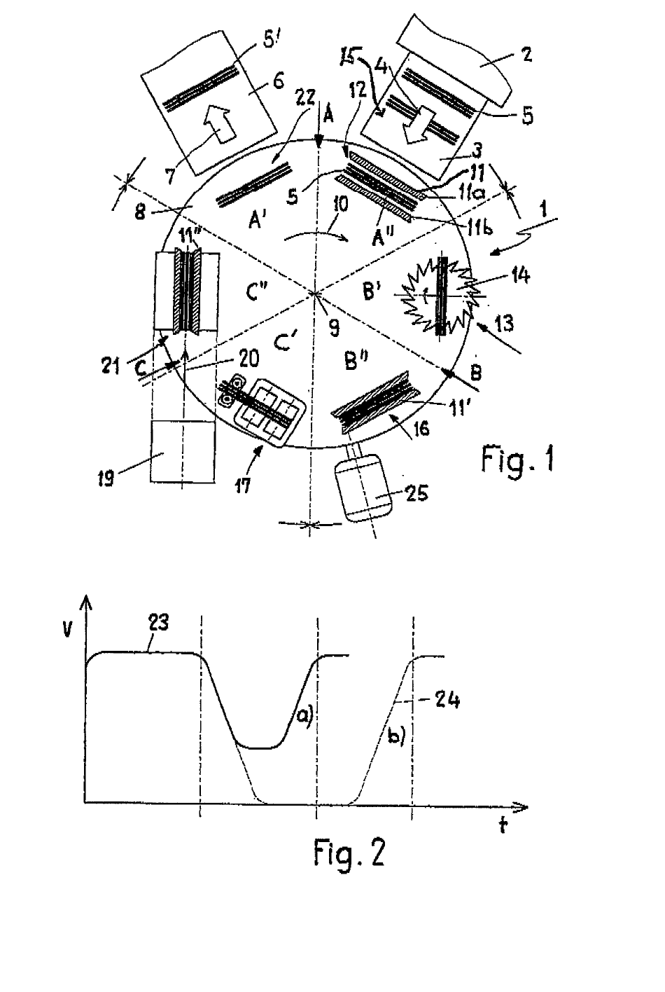

Referring to the drawings, an arrangement is shown in FIG. 1 which comprises a revolving table 8, driven by a controllable motor 25 so as to revolve around a vertical axis 9 in a direction of arrow 10. Other circulating conveying devices can also be used in place of the revolving table 8 in which, for example, an oval conveying path is employed.

Three grippers 11, 11′ and 11″ that respectively comprise two movable jaws 11a and 11b are arranged on revolving table 8. These grippers 11, 11′ and 11″ each serve to hold a book block 5 to be processed.

A feeding device 3 supplies the revolving table 8 with the book blocks 5 to be processed, wherein the loose book blocks 5 are supplied in the direction of arrow 4 of a gripper 11. A printing machine 2, for example a digital-print machine, creates the sides of the loose book blocks 5. The feeding device 3 preferably has a buffer section 15 in which several loose book blocks 5 are stacked, for example, and are supplied on demand to the revolving table 8. The feeding device 3 transfers the loose book blocks 5 to the revolving table 8 at an input station 12, which is shown in the 1 o'clock position in FIG. 1. FIG. 1 shows a removal station 22 that includes a removal device 6 arranged in the 11 o'clock position for removing the book blocks 5′ in the direction of arrow 7. The removal device comprises a conveying belt (not shown) and removes the processed book blocks 5′ that have already been provided with a cover 19, and supplies these book blocks for further processing, for example, to a cutting device not shown herein.

The input station 12 and the removal station 22 form a section A, which extends from the 10 o'clock position to the 2 o'clock position, over an angle of 120°. The two processing stations 12 and 22 are arranged side-by-side, as can be seen.

An additional section B that also extends over 120° is provided with a routing station 13, a routing device 14 and a book lowering station 16. Stations of this type are known per se to the person skilled in the art.

A third section C comprises a gluing station 17, as well as a cover feeding and cover press-on station 21, wherein this section C also extends over 120°.

As can be seen, each of these sections A, B and C extends over an angle of 120°. The revolving table 8 is driven wit the aid of motor 25 such that the rotational speed in the first sections A′, B′ and C′ is respectively different from the rotational speed in the second sections A″, B″ and C″. In particular, the revolving table 8 is operated in such a way that the speed in the sections A″, B″ and C″ is lower than in the sections A′, B′ and C′. It is thus achieved that the processing stops sections A″, B″ and C″ can be carried out at a lower speed or even during the standstill. In particular, inserting the loose book block 5 at the input station 12, lowering and aligning the book block 5 at the book lowering station 16, as well as pressing the cover on following the adhesive application at the cover press-on station 21 can be carried out at a comparably low speed or even during a standstill. The loose book blocks 5 additionally do not need to be inserted at full operating speed at the input station 12. The covers 19 also do not have to be pressed on while passing through, which considerably improves the processing quality.

The two curves 23 and 24 in FIG. 2 are examples for a differing pass-through speed. For the course according to the curve 23, the revolving speed of the table 8 is comparably high and essentially constant for the processing in sections A′, B′ and C′. Subsequently, the speed is lowered continuously and kept constant in some sections for the processing in sections A″, B″ and C″. At the end of this processing cycle, the speed is raised again. For a processing according to the curve 24, the processing in sections A″, B″ and C″ occurs during a comparatively long standstill period. During this standstill period, for example, the loose book blocks 5 can be fed to the input station 12 and a cover 19 can simultaneously be pressed on at the cover press-on station 21.

Also conceivable is an arrangement with more than three sections. For example, a section can be installed upstream, which is not shown herein and forms a vibrating station. The section is designed to align the sheets in the loose book blocks 5. In addition, stations for inserting, depositing or addressing are conceivable as well, which can either be additional stations or can replace the above-mentioned stations.

The invention has been described in detail with respect to preferred embodiments, and it will now be apparent from the foregoing to those skilled in the art that changes and modifications may be made without departing from the invention in its broader aspects, and the invention, therefore, as defined in the appended claims is intended to cover all such changes and modifications that fall within the true spirit of the invention.

What is claimed is:

1. An arrangement for processing printed products, comprising:
a conveying device for conveying the printed products;
a feeding device for feeding the printed products to the conveying device;
a plurality of processing stations arranged along the conveying device for processing the printed products; and
a removal device for removing the printed products from the conveying device;
wherein several of the processing stations are subdivided into at least two sections, each section including at least two processing stations, and the arrangement further includes means for passing the products through each section with a differing speed.

2. An arrangement according to claim 1, wherein one of the sections comprises an input station ad a removal station.

3. An arrangement according to claim 2, wherein another of the sections comprises a routing station and a book block lowering station.

4. An arrangement according to claim 3, wherein a further one of the sections comprises an adhesive application station, a cover supply station and a cover press-on station.

5. An arrangement according to claim 4, wherein the arrangement comprises a circular/adhesive binding machine.

6. An arrangement according to claim 5, wherein the feeding device comprises a buffer section.

7. An arrangement according to claim 6, wherein each section includes a first processing station and a subsequently following, second processing station, and the pass through speed for the processing in the first processing station differs from the pass through speed in the second processing station

8. An arrangement according to claim 7, wherein the speed in the second processing station is considerably lower than the speed for the processing in the first processing station.
